(19) United States
(12) Patent Application Publication
(10) Pub. No.: US 2002/0112240 A1
(43) Pub. Date: Aug. 15, 2002

(54) Method and system for targeted content presentation in a communications network

(76) Inventors: Stephen R. Bacso, Kitchener (CA); Rene J. Juneau, Thornhill (CA); Sanjeev Shankar, Waterloo (CA); Bruce D. Scanlan, Waterloo (CA)

Correspondence Address: SHUMAKER & SIEFFERT, P. A., 8425 SEASONS PARKWAY, SUITE 105, ST. PAUL, MN, 55125, US

(21) Appl. No.: 09/991,525

(22) Filed: Nov. 20, 2001

(30) Foreign Application Priority Data
Nov. 20, 2000 (CA) 2,326,368

(51) Int. Cl. G06F 3/00; H04N 5/445; G06F 13/00; H04N 7/173

(52) U.S. Cl. 725/47; 725/50; 725/114; 725/118

(57) ABSTRACT

The present invention relates to a method and system for targeted content presentation in a communications network. In accordance with the present invention, there is provided a method for targeting content to users in a communications network; the method comprising the steps of determining targeted user characteristics and presenting content in accordance with said characteristics. In accordance with the present invention, there is further provided a method for targeted content presentation in a communications network for regularly scheduled content opportunities, the method comprising the steps of: monitoring the programming stream for opportunities and content descriptors; determining the source for alternate content; matching the opportunity to the available content and the viewer characteristics; presenting In one embodiment, the system includes a delivery engine, a matching engine, a combiner, and a micro decision engine (MDE).

### PRIORITY CLAIM

The present application claims priority from Canadian Patent Application 2,326,368 filed Nov. 20, 2000, and pending U.S. patent application Ser. No. 09/687,449 filed Oct. 13, 2000 entitled ‘Method and System for Targeted Advertising’, the contents of which are herein incorporated by reference.

### FIELD OF THE INVENTION

The present invention relates generally to methods and systems for providing content in information systems, and more particularly to a method and system for targeted content presentation in a communications network.

### BACKGROUND OF THE INVENTION

While television is still by far the most popular medium for entertainment and information, television technology had until recently remained relatively unchanged since its introduction in the 1950s. However, the recent emergence of digital television environments has reflected the convergence of conventional television broadcasting and the digital format.

Existing digital television systems, whether broadcast systems such as over-the-air NTSC or ATSC, cable television, DTH satellite or microwave, point-to-point data systems like the Internet, or switched systems using DSL in all its variants including ADSL, dual ADSL and VDSL, now simultaneously transmit hundreds, even thousands of services, each including one or more streams of audio, video, data, or interactive applications.

While prior art techniques can be used to deliver programming and advertising content in digital television systems, it is desirable to provide content in a manner that utilizes the digital format's targeting potential. The Internet has been viewed by some as a superior technology because of its growing potential for targeting programming and advertising content based on user input and information, and for identifying the end-user and reporting back on their selection of and response to that programming and advertising content, hereinafter referred to simply as content. Examples of content include television or radio programs, computer games, images, and news and stock tickers.

It is further desirable to target content according to accumulated end-user information such as interests and demographics, thus allowing for a “push” model of targeted content provision. In such a model, content would be selected based on known characteristics of a target audience, characteristics provided in real time and/or from storage. It would be further desirable to provide targeting of content in granularity ranging from large groups of individuals down to a single end-user. The art, in its current state, is incapable of achieving these goals.

Existing Internet solutions for delivering both targeted and non-targeted content to users over the Internet typically require user interaction that “pulls” content from servers. Pull-driven solutions are inappropriate for real-time broadcast television environments since the potential number of request events created by viewers, and the specific content that would need to be delivered to those viewers, cannot be supported in existing communications systems.

As well, there are no standards or consistencies across platforms. Multiple Service Operators, which typically have heterogeneous networks, deploying a targeted content solution from a specific provider would only have the solution supported on a portion of their network. What is needed is a method of providing content in a targeted push model using the superior technology of the Internet.

Any proposed solution should make innovative use of legacy receiver facilities and technology, work with official and de-facto standards for transmission and interactivity, and be adaptable and usable by new receivers while maintaining compatibility and interoperability with legacy systems. Digital receivers are rapidly evolving with capabilities like dual-tuners, disk drives for program recording and playback, and high-speed Internet access. Any proposed solution should be capable of exploiting these capabilities to create new opportunities to provide content, as well as new forms for content.

Further, any proposed solution should be able to evolve to accommodate new receiver capabilities, and capable of accessing content not only from transmitting streams, but from local disk storage, near-local storage through network or switched connections like VDSL, and faster Internet connections.

Proposed solutions should be capable of targeting many forms of content, from data to television programs to interactive applications, all while working in an interactive or passive environment. Any proposed solution should be capable of handling the above considerations in end-user equipment provided at a reasonable cost, and with consideration for any existing technological system limitations.

For the foregoing reasons, there is a need for an improved method of presenting targeted content.

### SUMMARY OF THE INVENTION

The present invention is directed to a method and system for targeted content presentation in a communications network. The method includes the steps of the present invention is directed to a method and system for targeted content presentation in a communications network.

In accordance with the present invention, there is provided a method for targeting content to users in a communications network; the method comprising the steps of determining targeted user characteristics and presenting content in accordance with said characteristics.

In accordance with the present invention, there is further provided a method for targeted content presentation in a communications network for regularly scheduled content opportunities, the method comprising the steps of: monitoring the programming stream for opportunities and content descriptors; determining the source for alternate content; matching the opportunity to the available content and the viewer characteristics; presenting In one embodiment, the system includes a delivery engine, a matching engine, a combiner, and a micro decision engine (MDE).

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a system for targeted content presentation in communications networks according to an embodiment of the present invention;

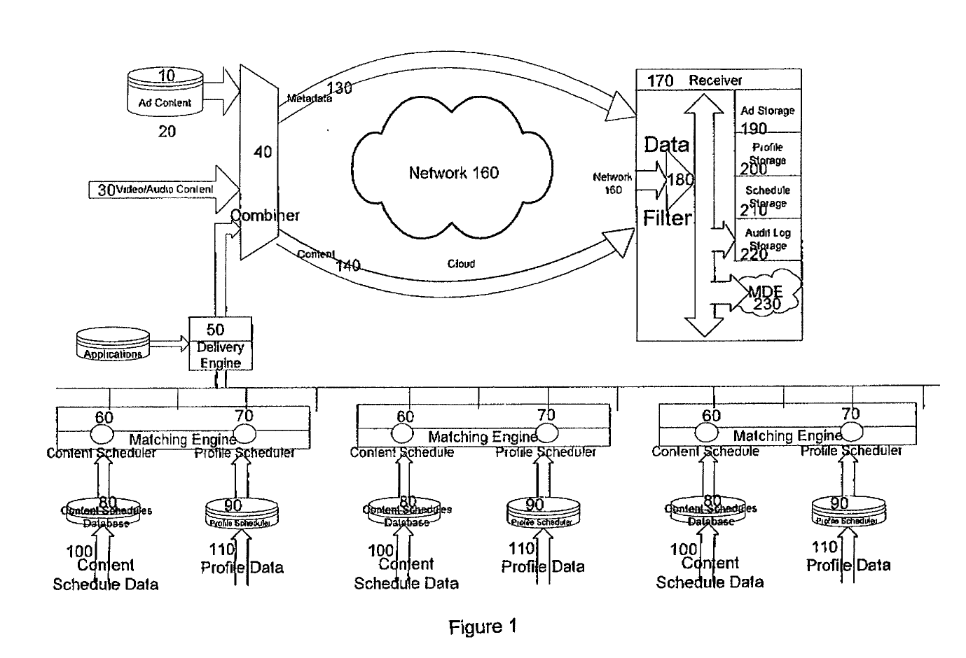

FIG. 2 shows an automated reporting system in accordance with the present invention;

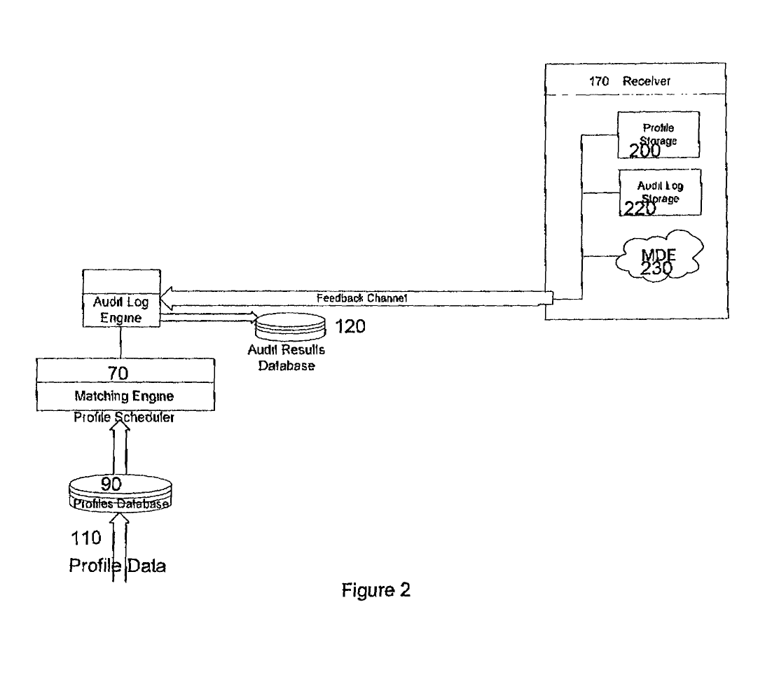

FIG. 3 shows a system for presenting target content system in accordance with the present invention;

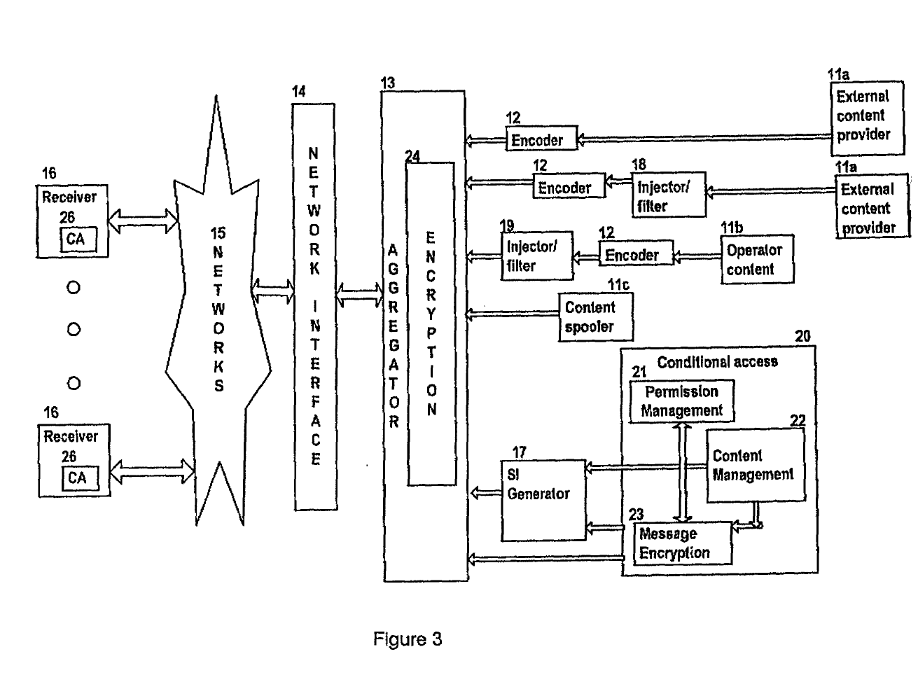

FIG. 4 shows a receiver system in accordance with the present invention;

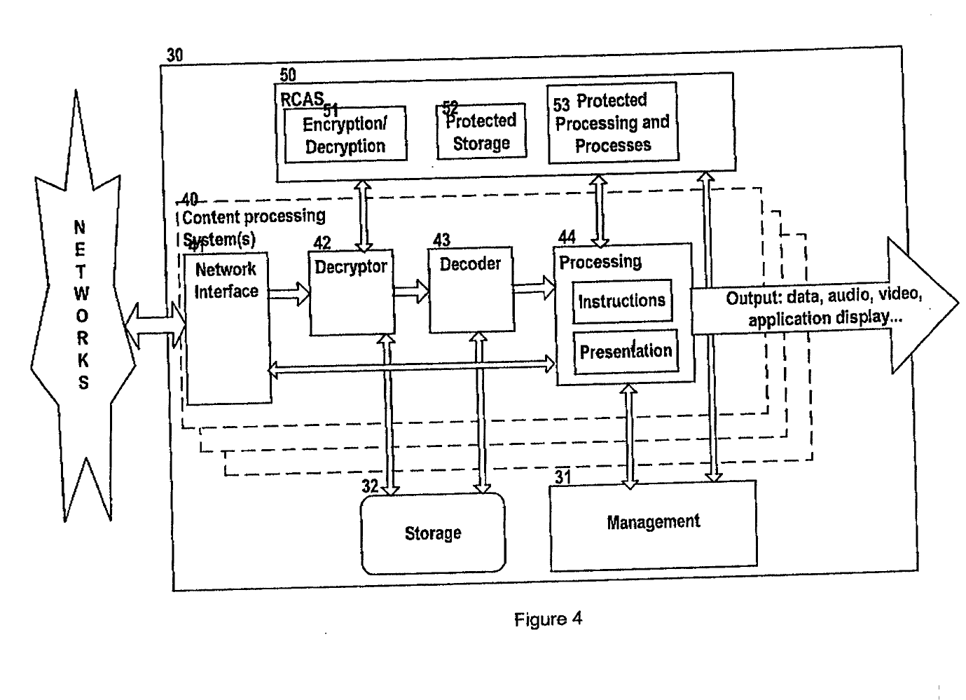

FIG. 5 shows a method for presenting targeted content in accordance with the present invention;

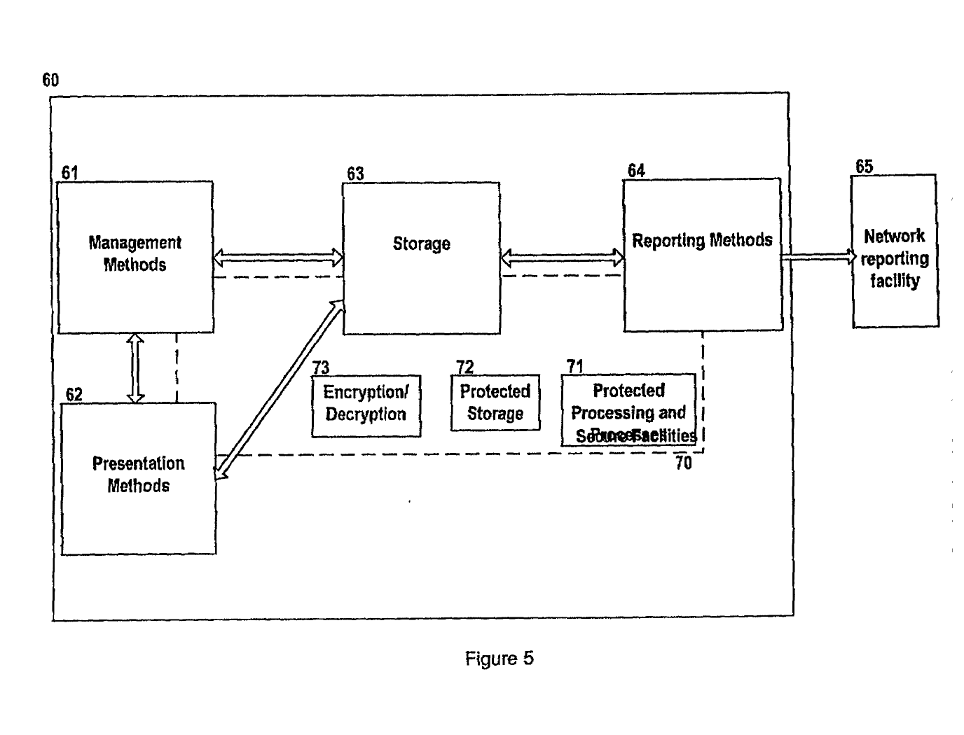

FIG. 6 shows a method for presenting targeted content in accordance with the present invention;

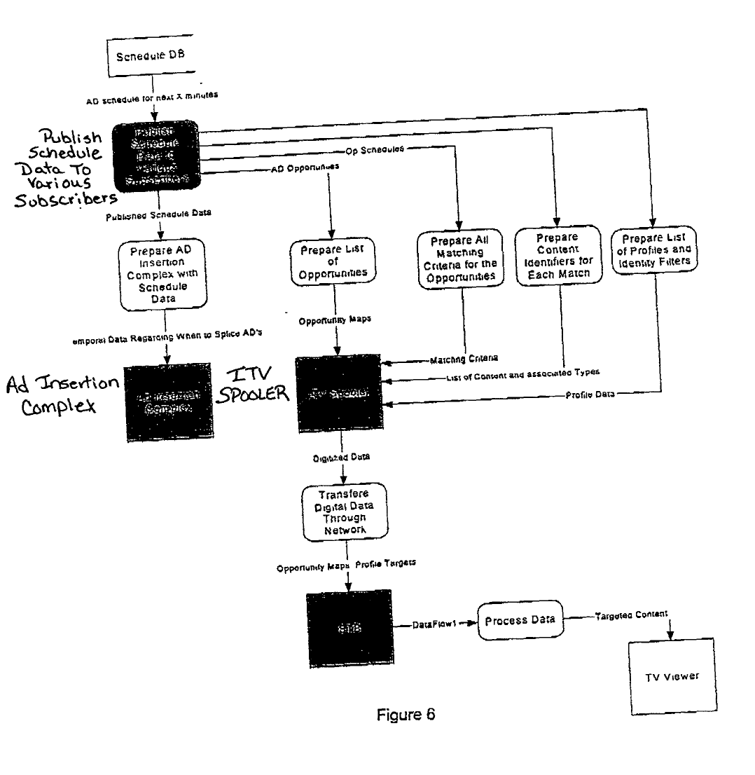

FIG. 7 shows a method for presenting targeted content in accordance with the present invention;

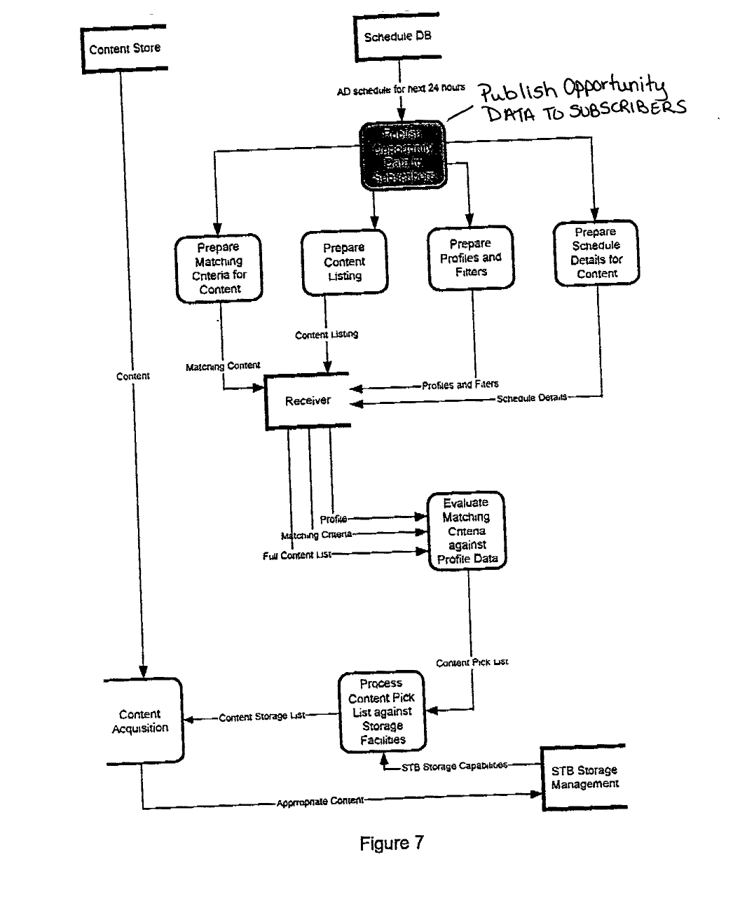

FIG. 8 shows a method for presenting targeted content system in accordance with the present invention;

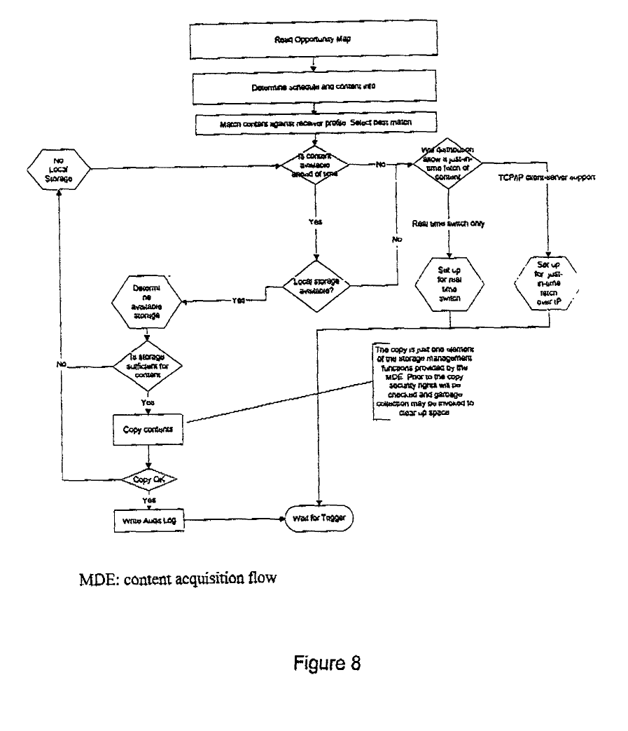

FIG. 9 shows a method for presenting targeted content system in accordance with the present invention;

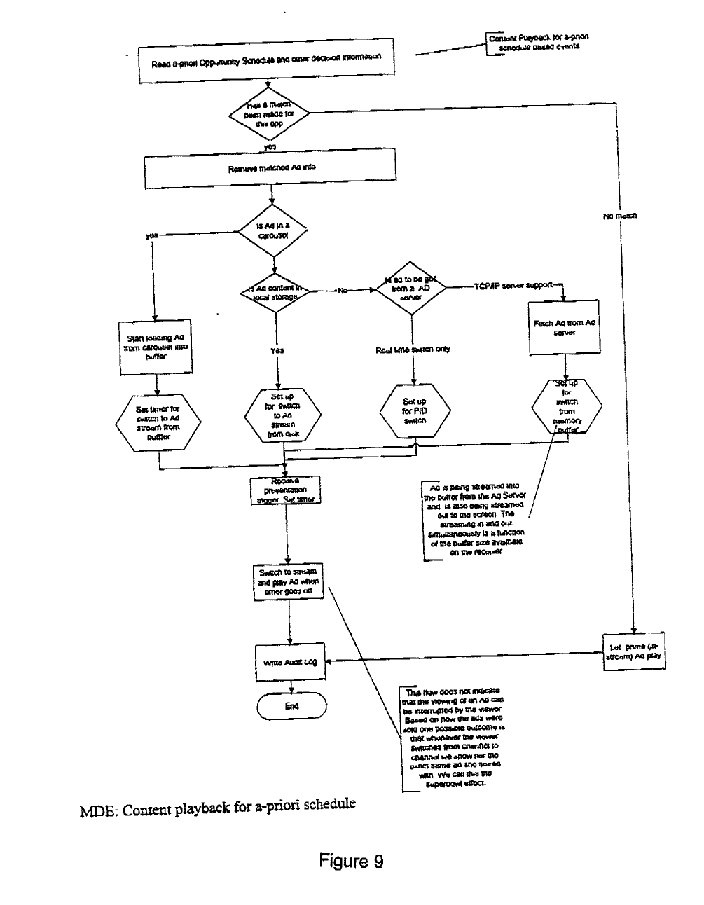

FIG. 10 shows a method for presenting targeted content system in accordance with the present invention; and

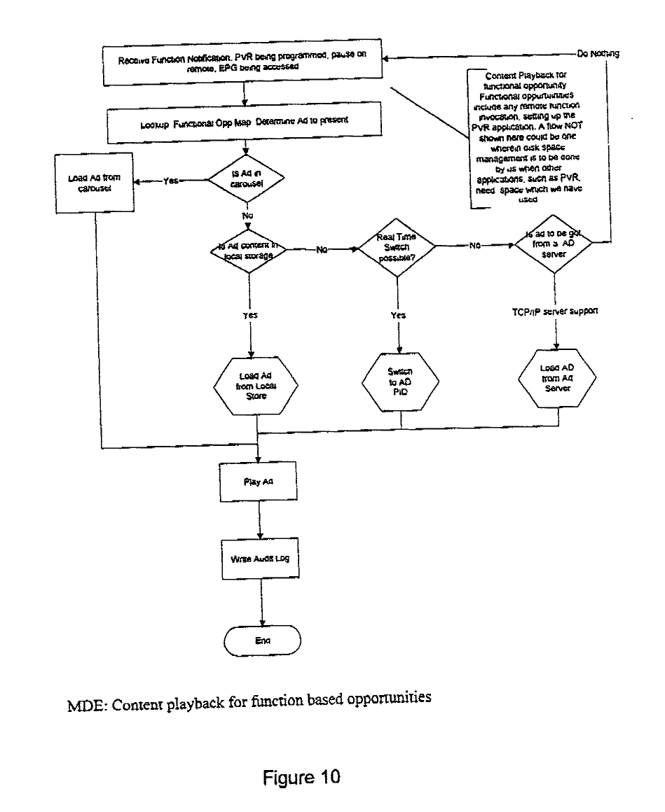

FIG. 11 shows a method for presenting targeted content system in accordance with the present invention.

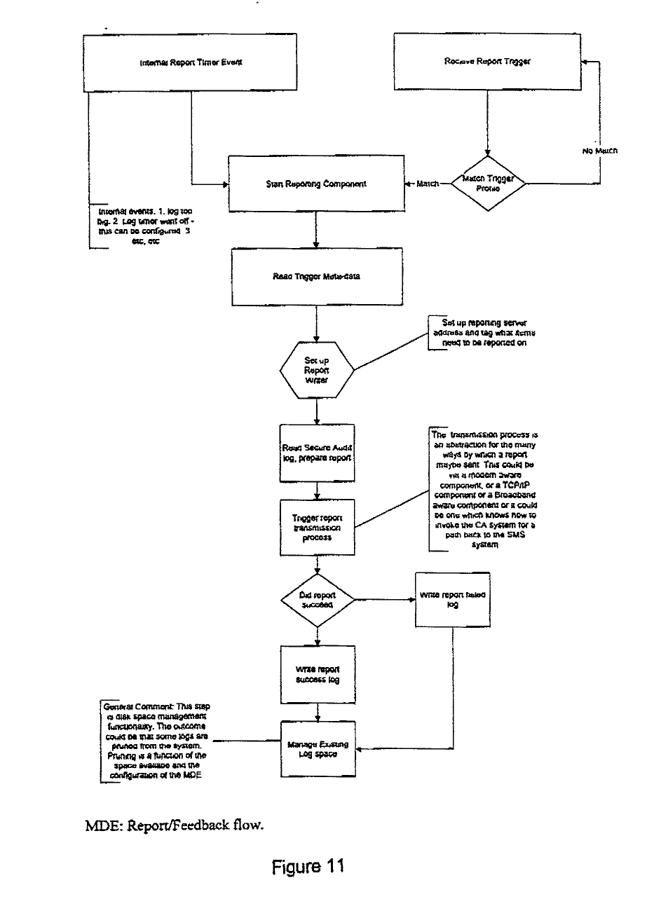

### DETAILED DESCRIPTION OF THE PRESENTLY PREFERRED EMBODIMENT

The present invention is directed to a method and system for targeted content presentation in a communications network.

In accordance with the present invention, there is provided a method for targeting content to users in a communications network; the method comprising the steps of determining targeted user characteristics and presenting content in accordance with said characteristics.

In accordance with the present invention, there is further provided a method for targeted content presentation in a communications network for regularly scheduled content opportunities, the method comprising the steps of: monitoring the programming stream for opportunities and content descriptors; determining the source for alternate content; matching the opportunity to the available content and the viewer characteristics; presenting In one embodiment, the system includes a delivery engine, a matching engine, a combiner, and a micro decision engine (MDE).

The matching engine, delivery engine, and combiner are located at one or more facilities head-end, while are located at network points and/or on receivers connected to viewing devices such as televisions and personal computers.

The matching engine is responsible for generating schedules, meta-data and triggers that, combined with content, are broadcast via the delivery engine to MDE's. The matching engine also communicates with the delivery engine to forward configuration triggers that inform an MDE of a requirement to replace particular MDE sub-components in part or in whole.

The delivery engine is located at network broadcast points and is responsible for ensuring the coordination and delivery of profile data and content. The delivery engine can be deployed across a plurality of hardware platforms at one or more points to support load balancing and capacity planning needs.

The base MDE can either be embedded within receiver software or streamed out by the delivery engine and loaded onto receivers from the broadcast stream. The base MDE examines its receiver environment for available functionality, and can use this information to load additional constituent sub-components.

The invention uses data management and broadcast techniques that map to a broadcast environment to provide desirable targeted content delivered to subscribers' receivers without requiring subscriber interaction. The system provides targeting of content based on a balancing of receiver capabilities and/or viewer profiles.

The delivery engine sends meta-data and triggers, via the combiner, through the broadcast network to the MDE for the purposes of targeted content delivery and presentation. System middleware elements collect information from the combiner that broadcasts reporting meta-information to the receivers using standard broadcast equipment such as MPEG2 multiplexers and encoders.

MDE's are responsible for “understanding” regular broadcast schedules, setting up and managing demographic profiles, recognizing functional opportunities described as user interactions, collecting appropriate targeting content, and storing selected content on the receiver. MDE's make final decisions on how best to provide targeted content to the viewer. Opportunities for targeting content are created at network operator sites and are sent to collections of digital receivers for processing and presentation of targeted content. Targeting opportunities can also be provided at the receiver, and are the subject of the Applicant's pending application filed Oct. 13, 2000 Ser. No. 09/687,449 entitled “Method and System for Targeted Advertising”.

In an embodiment of the present invention, the system can further include a reporting component for providing updated profile information, and is the subject of the Applicant's co-pending application entitled “Method and System for Automated Reporting in a Communications Network”. In this reporting embodiment, the MDE is further responsible for creating and managing audit logs for reporting back on user viewing data.

The MDE receives profile information on viewers from the matching engine using the delivery engine. The matching engine manages and controls the delivery of such information received from broadcasters and multiple services operator; information that can be based on subscription information provided to the operator by the viewer and/or information the operator has acquired from other sources. The viewer profile data can be forwarded in encrypted or unencrypted format. In an embodiment of the present invention, the data is kept in encrypted format within the facilities of a conditional access system to prevent unauthorized access, as would be known to persons skilled in the art. In this way, the processing may prohibit the retrieval of data by unauthorized functions or functions outside of the secure facilities, with only the results of the match returned to the requesting method.

The MDE collects targeting content, profile information and schedule information, prepares its work environment, and can be dynamically modified on any given receiver to provide real-time updates, thereby dynamically adapting it to the receiver and to particular broadcast environments. Content targeting occurs on each receiver according to the features available on that receiver.

MDE updates are embedded in metadata regularly broadcast to receiver components. New and/or additional MDE's can accommodate different receiver capabilities, middleware systems, application execution environments, network technologies and bandwidth, security systems, network operator requirements thereby supporting multiple heterogeneous infrastructures and varying receiver capabilities. Multiple instances of the MDE can be generated to match technology and requirements.

Metadata carousels present descriptions of available targeted content. Carousels are the subject of the Applicant's co-pending application entitled “Method and System for Dataflow Management in a Communications Network”. The most up-to-date versions of MDE's are delivered across carousels, and can replace themselves at any time with a more appropriate MDE, or can remain resident on the receiver. An MDE configuration can be changed dynamically using the matching engine that directs the system to multicast the appropriate MDE.

The targeting of content is broadly defined as the exploitation of opportunities to present viewers with one of a number of alternative versions of content. Targeting opportunities can be based on segments of content that can be substituted for alternate segments, based on dynamic alteration of the content, and on presentation based on the invocation of functions by the user.

Storage of targeted content can be provided on receivers in the form of persistent storage, if such facilities are available on the receiver, and/or can be provided in the form of temporary storage. MDE's are preferably located on receivers, but can be located on other intermediate network components in situations where limitations exist with receivers or where appropriate based on network characteristics or both. Since there are a variety of application platforms used by receiver vendors, the implementation of the MDE is tailored to a particular platform, with each platform having its own version of an MDE.

Content from the server can be transmitted in real-time, or slower or faster than real-time to cache content for deferred viewing. Content may flow into pre-processing devices that pre-process the content before distribution such as encoders, encryption devices, and packetizers. From these devices, the processed content flows into a combiner for delivery, through a network interface to via a network for delivery to a plurality of receivers.

In an embodiment of the present invention, the configuration for the MDE is based on demographic parameters such as geographical location and/or postal codes. In addition to receiver information, algorithms within the MDE can access the demographic parameters themselves, which can originate from the head-end and/or from data obtained or derived from viewer interaction.

The invention is capable of functioning in receivers lacking persistent storage capabilities. As well, the invention enables the management and synchronization of targeted content delivery across heterogeneous networks, by adapting receiver-based targeting applications to receiver and supporting network environments. The invention provides allocation management of resources on the receiver in an environment where multiple interactive services may be competing for the same resources like disk space and memory storage.

Physical embodiments of receivers include digital set-top cable and satellite receivers; integrated components within digital televisions; personal computers with appropriate network connections, gaming consoles, and cellular telephones and personal digital assistants connected through wireless networks and occasional computer network hook-ups. A receiver's functions may be contained within local equipment or distributed throughout a network. For example, when using xDSL equipment or the Internet, a channel change request to a set-top receiver can send a signal to control equipment on the operator's network, which changes the program stream being transmitted to the receiver, operating alone or in combination.

Content includes audio, video, data, applications, or any combination thereof, which is made available to a viewer by broadcast or point-to-point transmissions or requests for content. Examples of content include television or radio programs, computer games, images, and news and stock tickers.

When an opportunity for content targeting is presented, appropriate content is selected to exploit the opportunity. In this way, the content the viewer receives can be specifically tailored to the viewer and/or receiver type, without the tailoring and selection process necessarily being apparent to the viewer. While user input is not required, data and preferences entered or selected by the user can be incorporated in the process.

In an embodiment of the present invention, an opportunity is provided by advertisements located at pre-determined points within a television program. Viewers selecting the program see the same program, but may receive different versions of advertisements based on parameters set by the broadcaster. The locations of advertisements within the program can be relative to the start of the program or based on a trigger in the program stream, so that the opportunities can be used whether the program is broadcast live or replayed from storage.

In an embodiment of the present invention, scheduled segments within a television program provide the opportunity, and the segments the viewer sees are based on parameters selected by the broadcaster. For example, during a news show, a specific section of the show allows the viewer to see more business, sports or entertainment news, based on the viewer's preferences.

In an embodiment of the present invention, the opportunity can be provided by information within a game, graphical application or video program that allows a portion of the content to be replaced. For example, a baseball video game or program can include a background billboard, which is used to display an advertisement, in still or moving video form. The advertisement is selected based on parameters and functions set by the programmer.

In an embodiment of the present invention, an opportunity is provided by the invocation of a receiver function by the viewer. Examples of function-based opportunities include the triggering of content display when an electronic program guide (EPG) function is selected, or when playback, application or game control functions such as ON, OFF, FF, REW, and PAUSE are used on appropriately equipped receivers. The algorithm for assessing the opportunity not only matches the content to the opportunity, but also determines if the opportunity will be exploited in this invocation by assessing the timing of prior function invocations. In an embodiment when the viewer first turns on the receiver, a short advertisement that has been cached on the receiver is displayed before other content can be viewed. Use of other functions like PAUSE or PLAY can result in ads being played, with the ad designed to match the opportunity.

Metadata includes content information, information on opportunities for presenting the content, and information and processes for matching content to opportunities. Metadata and content are transmitted to digital receivers. The metadata is contained in existing or new transmission structures and facilities, and relates to the co-transmitted content or to content available from other sources, synchronously or asynchronously.

Management methods in the storage manager component of the MDE monitor the transmitted stream and provide storage and storage management mechanisms for alternate versions of content, acquire content from alternate sources, control access to the storage and data, and securely acquire, store and retrieve characteristic information used in the selection process.

Presentation methods in the presentation manager component of the MDE display the content based on opportunity information from the transmission stream, opportunities created by function invocation by the user, physical and temporal content availability, and processes for matching the content to the opportunities. The matching process may have complex requirements including multi-service broadcaster requirements, multi-message content sequencing, and user preferences including ratings and permissions such as those used in implementations of technology used to broadcast ratings with the programming and allow receivers to block viewing of programs with ratings deemed inappropriate. Combinations of all of the above methods provide precise timing and event synchronization capability for the presentation of content.

Table 1 shows a list of content and related characteristics. The content type 81 enables the receiver to determine if it is capable of showing the content. For example, alternate versions of a single ad may be available as different audio/video clips or as a graphical application with interactivity options. A receiver without interactivity can ignore the application version. The type can be represented as a value or as a data structure representing complex options within the piece of content. In an embodiment of the present invention, the data structure can be represented as a data structure showing both the properties and the requirement for presenting those properties. As shown in Table 2, clip “Ad 1 with optional interactivity” indicates that audio, video and interactivity are present in the clip, but interactivity is not required. A receiver not equipped for interactivity could still show only the audio and video. Clip “Ad 2 with mandatory interactivity” has audio and video that is directly tied to the interactive component, and is not to be used by this type receiver.

| | | Content | | Content |
|---|---|---|---|---|
| Descrip- | Content | Source | Content | identifier |
| tion | type 81 | 82 | charadteristics 83 | 84 |
| Ad 1 with | Audio = yes, | Channel | Area = California, | 1111 |
| optional | video = yes, | 204 real | type = tv ad | |
| inter- | ATVEF | time | | |
| activity | interactiviy = yes | | | |
| Ad 2 with | Audio = yes, | Channel | Area = MidWest, | 1112 |
| mandatory | video = yes, | 205 real | type = tv ad | |
| inter- | ATVEF | time | | |
| activity | interactiviy = | | | |
| | mandatory | | | |
| Ad 1 of 3 | Audio = yes, | Internet | Area = everywhere | 1113.1 |
| for new | video = yes | | else, type = tv ad | |
| car model | | | | |
| Ad 2 of 3 | Audio = yes, | Internet | Area = Northern | 1113.2 |
| for new | video = yes | | states, type = tv ad | |
| car model | | | | |
| Ad 3 of 3 | Audio = yes, | Internet | Area = Southern | 1113.3 |
| for new | video = yes | | states, type = tv ad | |
| car model | | | | |
| Ad 1 for | Audio = no; | Channel | Area = all, | 1114 |
| play | video = yes, | 206 | type = pause ad; | |
| during | ATVEF | 14:02 | duration = 30 | |
| pause | interactivity = yes | | | |
| Ad 2 for | Audio = no; | Channel | Area = all, | 1115 |
| play | video = yes, | 206 | type = pause ad, | |
| during | ATVEF | 14:04 | interruptible = no; | |
| pause | interactivity = yes | | duration = 5 | |

The content source enables the receiver, based on its capabilities, to determine if content is accessible. Content characteristics describe targeting attributes of the content. The number and types of characteristics are dynamic and can grow or change over time, as would be known to persons skilled in the art. Content characteristics can include temporal sensitivity includes the maximum or minimum showings per time interval, minimum intervals between showings or a time window in which the content can be used, repeatability such as maximum number of showings, characteristics for matching the content to the opportunity, conditional access system control information, opportunity type, and access rights to identify the source of the content.

Use of access rights is particularly important for operators, as fees and technical considerations may be required for the operator to allow the application to be transmitted. As an example, commands for network callback may be contained within the interactive stream, but not permitted for all applications based on access rights available to the specific MDE/receiver. The access rights will be generated by the operator or the matching engine and streamed to the MDE.

The content identifier is a unique code used for storage, and retrieval and for reporting content usage. The identifier can further include a sequence component to indicate that the content in question is one of many in a series, and its sequence within that series.

Access rights within the characteristics are used to ensure that the content, and in particular its use of resources like storage, and network and processing facilities is appropriate to the receiver and the operator's network(s). Message encryptors can be used and are commonly implemented in conditional access and Internet systems, and implementation details will occur to those of skill in the art.

Table 2 shows a list of content display opportunities. The opportunity type describes how the content display opportunity is initiated. Mechanisms include an absolute schedule with a time at which content must be presented; a relative schedule having a time relative to another event or trigger, and a function invocation where the use of a feature on the receiver can trigger the display of content.

TABLE 2
List of content and related characteristics

| | Opportunity | | | | | |
|---|---|---|---|---|---|---|
| Opportunity type | Content 86 | Opportunity | Opportunity | Opportunity | Opportunity | |
| 85 | Source 82 | Context 87 | method 89 | descriptors 90 | identifier 88 | Description |
| Type = absolute | 1111,1112 | channel = CNN; | geography_{—} | | 2111 | Ad insertion |
| time; time = (14:02; | | | match | | | opportunity 1 on |
| 14:04) | | | | | | CNN |
| Type = relative | 1111,1112 | channel = (CNN, | Income_match | 1111 if < | 2112 | Ad insertion |
| time; time = (trigger | | HNN, CNNFN); | | 100000; | | opportunity 2 on |
| 2112 = 300 | | | | 1112 if > = | | any of CNN, HNN |
| frames | | | | 100000 | | or CNNFN |
| Type = function | 1113.X | function = on | play_all_in_{—} | | 2113 | Ad insertion when |
| | | | sequence | | | receiver started |
| Type = function | 1114, 1115 | function = pause_{—} | match_to_{—} | | 2114 | Ad insertion when |
| | | return | pause_{—} | | | returning from |
| | | | duration | | pause | |

The opportunity content list shows the content that can be selected for display. This field is related to the content identifier of Table 4. The opportunity context determines when and where the content is to be displayed, a specific stream where the content can only be displayed on a given service, a group of streams where the content can be displayed on any one of a plurality of services, a time window for function invocation where the content is to be displayed if the user hits the PAUSE button between contains times, or the invocation of a function on the receiver such as a channel change.

The opportunity identifier uniquely identifies the opportunity for reporting purposes. Function invocations are based on viewer input through receiver controls, including switches on the receiver, remote controls, mice, keyboards and other input devices, and commands and trigger signals sent with the video; commands sent across a wired or wireless network through other devices. Opportunities are tailored for a receiver's capabilities, and can be based on the invocation of a series of one or more functions, and/or the timing and context of the function invocation. A result of a condition test involves the execution of a complex function in which a variety of conditions can occur based on data from the network and input from the user.

Algorithms can be designed to use multiple facilities to ensure a high probability of showing a sequence of content within a give timeframe with a high degree of independence of the content being watched. For example, a content provider with multiple services can request that a series of advertisements be presented in sequence between 20:00 and 22:00, taking advantage of opportunities occurring on all their services from function invocation. For each advertisement in the series, multiple versions can be available, and the matching algorithms for the opportunities will make the appropriate selection.

The opportunity method used by the MDE indicates which method should be used to match the opportunity to the content. The method can be a reference to a function available in the MDE or receiver, a function that is acquired from the network, a function that is included in the opportunity descriptor, or a combination of these with the appropriate method or combination of methods being selected based on the capabilities of the receiver and connected network.

In an example, the opportunity with description Ad insertion when user returns from PAUSE in Table 5 uses method match_to_pause_duration, and the selection is based on the viewer returning to viewing after selecting the PAUSE function. This method is designed to minimize the annoyance of the user, and is based on the duration of the PAUSE and the time since PAUSE was last used. The results of the algorithm are that the ad will not be shown if there was a return from PAUSE in the last 5 minutes. If the PAUSE was used within the last 30 minutes, then an ad will be selected that is less than 10 seconds in length. If the PAUSE has not been used in the last hour, then an ad of 30 seconds or less will be played.

The opportunity descriptor is a data set that matches viewer group characteristics with a probability for each viewer group to be a viewer during the opportunity. Processes and methods for this type of match can be found in the applicant's co-pending application entitled “Method and System for targeted Advertising”. As is the case for content descriptors, the opportunity descriptors can include encrypted components using the necessary encryption and decryption schemes.

As described in prior art, multiple versions of a television channel can be transmitted synchronously, and using a variety of mechanisms based on user input, the receiver can switch between the different channels to create a custom version of the program.

This invention enables several mechanisms for synchronous content transmission. One method involves synchronization of multiple streams of unrelated content. The streams are related only for targeting purposes, and not by their content. Each stream has different ads, however the timing of the ads is synchronized across the streams. At the start of each ad, the receiver can switch to a different channel for the duration of the ad if the ad on the other channel is determined to be more appropriate, or if it is a version of an ad that has not been seen by the viewer.

Another method involves adding additional streams for alternate versions of the content. As in the first method, the streams are linked to a plurality of content streams that are related only for management purposes, and not by content. By scheduling advertisements at different times on the content streams, the alternate content streams can be shared among the principal content streams.

Another method makes capacity available by manipulating content streams to eliminate redundancy caused by simultaneous substitution on networks where regulations require that when the same program is broadcast simultaneously from a local provider and a foreign provider, that the local provider's program replace the foreign provider's program on the foreign channel broadcast. Current network implementations result in the local program being transmitted redundantly on both channels.

Another method makes capacity available by placing content on services that are not broadcast 24 hours a day. During the off periods, the bandwidth of the services can be used either within the service definitions, or as separate services that use the bandwidth resources of the off-air services.

In switched environments such as DSL networks and video speed Internet with sufficient pre-roll time content can be queued and selected at the appropriate time. Within xDSL and Internet environments, a single stream of content can be multicast to a plurality of receivers.

For asynchronous content transmission, any of the network mechanisms discussed, broadcast or point-to point can be used. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

Once the presentation of an alternative piece of content has started, the display of the content may or may not be interrupted by the use of functions like channel changes. A characteristic of the content or the opportunity can deem the content to be uninterruptible, in which case the content will play to completion before other functions are allowed to proceed. Another characteristic is conditional uninterruptability, in which case the content can continue to play if certain conditions are met. In the case of multiple content channels with synchronized ad start times described earlier, a change to one of the channels in which the opportunity is being co-coordinated would continue to play. Certain characteristics have priority over others, or a hierarchal structure.

A broadcaster or network operator typically must support multiple receiver and network types for the distribution of their content. The invention supports multiple network and receiver hardware and software combinations. Each of these possible combinations is referred to as a delivery model. Delivery models can be supported as elementary targeting mechanisms, where advertisers and broadcasters can choose to deliver content based on the capabilities of groups of receivers and their respective networks.

At the matching engine and delivery engine levels, the system retains and uses information about each delivery model and the various components of the distribution network. Information can include logic execution capabilities and specifications, network latency for specific services and equipment that affect presentation timing, receiver types and features, including memory, local and network storage, network connections and capabilities. Information can further include data available to receivers, bandwidth for delivery to receivers, number of receivers within each delivery model, viewer characteristics for each receiver.

This information is used for purposes such as consolidating feedback from network and receiver components into a common format for reporting to networks, advertisers and other parties, generating the algorithms for transmission to the receivers, management of and scheduling of transmission such as timing and bandwidth. The heterogeneous network support allows for the physical separation and independent management of components.

Matching engine functions can be located at broadcasters or other content providers, and can communicate with multiple delivery engine functions at other broadcasters and network operators. Network operator matching engines and delivery engines can in turn be receiving targeting information from multiple broadcasters and content distributors.

In applicant's co-pending application entitled “Method and System for targeted Advertising”, methods were shown for matching content to opportunities, and for using multiple parameters for weighting. Further information, methods and parameters are available within existing receiver implementations that can be used for content targeting.

Location information can be stored on digital receivers in the form of a zip or postal code, or a value derived from the zip, postal code or customer address to determine location, and can be used to determine time zone for clock display and scheduling functions, and as a geographical access control system for blackouts. Rudimentary profiles are available for presenting customized versions of the EPG to various users of the receiver, or to restrict accessible content for certain viewers. Modes and rating flags are set to lock out programming based on program rating, selected profiles, and categories of operation like pay-per-view purchases. Pay-per-view purchase histories are stored until they can be reported back to the operator.

Using this data allows simple targeting methods in existing receivers without having to implement additional data storage and related security for the targeting system. The data can also be used in conjunction with other data provided and managed specifically for content targeting purposes. The EPG profile currently in use can be added as a parameter to the viewing record to aid in identifying the actual viewer within a plurality of viewers using the receiver.

Blackout mechanisms are implemented using geographical area definitions are transmitted and matched to the receiver's location. Blackouts are divided into categories, and there can be a category for each sport, league or even team within a league. For each category, the operator's coverage area is divided into zones, the receiver belonging to a specific zone. Those of skill in the art know various mechanisms available for defining categories and zones and transmitting information to receivers.

Through use of existing blackout zone definitions, matching algorithms are provided with geographical coverage areas that can be used to match content to viewers. Using the same mechanisms, additional categories unrelated to sports can be created for use solely for content targeting.

In an embodiment of the present invention, a viewer profile includes a restriction on violent content. Presentations methods can take steps including assuming with a high probability that the viewer is a child based on the rating and channel selections in the provide, show an ad for a children's movie as opposed to an action or adult movie at the next opportunity to show an advertisement for a pay-per-view movie, report the likelihood of the ad having been viewed by a child when reporting back on the viewing result.

Resource management capabilities can be leveraged by entities owning or managing receivers for customers to control access to individual services, resources and/or information. This is particularly important when information is considered confidential to the viewer and should not be accessible to every interactive application transmitted to the receiver. The MDE can work with existing conditional access infrastructure to determine whether or not the MDE is authorized on behalf of a requesting agency to access those desired resources by taking into account the status of the requesting agency, as well as the nature of the request.

The basic MDE's structure is independent of receiver middleware, thereby providing a highly adaptive system that enables real-time upgrades to component features and performance characteristics to enhance or modify content targeting features without the need for middleware upgrades, providing enhanced flexibility and decreased maintenance costs. This flexibility enables the invention to be deployed in environments including cellular telephony networks, cable networks, IP-based networks, and consumer kiosks such as automated teller machines.

The invention dynamically adapts targeting and selection mechanisms to meet the changing needs of programmers and advertisers. Further, the MDE can interact with conditional access systems to provide authentication, authorization and privacy.

Security and authorization are provided by the conditional access system (CAS). The CAS determines what content the viewer is allowed to access. The CAS can include a content encryption system for protection of the content during transmission, permission management for control of authorizations on a per user or receiver basis, content management for controlling access to content, a message encryption facility to secure communication authorization and other messages for transmission, and a receiver component for communications with the operator's CAS and local secure storage of permission and content access information.

The invention uses existing commercial broadcasting infrastructure to deliver targeted content, providing network infrastructure operators with the ability to deploy the system on existing environments with little or no additional expenditures. The system is dynamically adaptable, providing such things as new reporting algorithms, improved functional capability, and component code fixes in real-time and in an automated manner.

The invention provides the ability to manage targeted content delivery through multiple elements of broadcast activity, from the placement of content from broadcasters and their proxies, through to multiple cable and/or satellite distribution networks, to the receiver at the customer premises. As well, in embodiments of the present invention, the system can feed back reporting data to appropriate head-end systems to improve targeting accuracy. The invention utilizes data management and communications techniques that are system-independent, enabling a head-end broadcaster to deploy a single solution across their entire network that may comprise infrastructure and receivers embodying a variety of incompatible systems.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A method for targeting content to users in a communications network; the method comprising the steps of:
determining targeted user characteristics; and
presenting content in accordance with said characteristics.

2. The method according to claim 1, for targeted content presentation in a communications network for regularly scheduled content opportunities, the method comprising the steps of:
monitoring the programming stream for opportunities and content descriptors;
determining the source for alternate content;
matching the opportunity to the available content and the viewer characteristics;
presenting content to the viewer; and
updating the secure audit log with the viewing result.

3. The method according to claim 2, further including the step of updating the secure audit log with the viewing result.

4. The method according to claim 1, for targeted content presentation in a communications network for functional/user interaction content opportunities, the method comprising the steps of:
monitoring the programming and content streams for opportunities and content descriptors;
pre-matching the opportunities to the available content and viewer characteristics;
determining the source for alternate content as described previously;
checking security rights at a function invocation to determine appropriateness of content insertion;
presenting the content to the viewer if appropriate; and
updating pre-matched opportunities for next function invocation.

5. The method according to claim 4, further including the step of updating the secure audit log with the viewing result.

6. A method according to claim 2, further including the steps of:
monitoring the content descriptor transmission stream;
matching the opportunity map descriptors with the receiver capabilities;
verifying that permission is available to access the content;
matching of the content descriptors to the viewer profile information;
selecting the descriptors with the strongest content match if local persistent storage is available to the MDE;
determining if the content is already in storage;
determining if the content can be acquired in a timely manner;
verifying access rights to storage if access rights are verified, verifying availability of storage;
determining if content can be deleted to make storage available by comparing matches of the new content with existing content in storage, and replacing content with weaker matches to make storage available;
acquiring content from the designated source; and
placing acquired content in storage.

7. The method according to claim 2, whereby the ME/DE also forwards configuration triggers that indicate to the MDE if certain components need to be replaced to enable dynamic adaptation of the system to new feedback algorithms, better functional capability, and/or component code fixes.

8. The method according to claim 2, whereby the MDE also receives profile characteristic information on the viewers from the operator.

9. The method according to claim 2, wherein the viewers profile data is encrypted to prevent unauthorized access.

10. The method according to claim 2, wherein the data is kept in encrypted format within the facilities of a CA system.

11. The method according to claim 2, wherein a plurality of instances of the MDE can be generated to match one or more of the capabilities and requirements of the system and the capabilities of the various receiver models on the network

12. A system for targeting content to users in a communications network comprising:
means for determining targeted user characteristics; and
means for presenting content in accordance with said characteristics.

13. The system according to claim 12, for targeted content presentation in a communications network, the system comprising:
a head end component having:
a content schedule component having:
a content schedule database; and
a content scheduler for accessing the content schedule database to provide schedule triggers;
a profile component having:
a profile database; and
a profile scheduler for accessing the profile database to provide profile triggers;
a matching engine for accessing the content schedule and profile components to match content to end-users;
a delivery engine for delivering the matched content; and
a combiner that receives the delivered matched content and combines it with available content streams;
a receiver component having:
a data filter for filtering data; and
a microdecision engine for providing the guidance and commands to present content to the end-user from the data filter; and
a data network between the head end and the end-user components for transmitting data.

14. The system according to claim 13, wherein the delivery engine is provided in a plurality of instances to provide for load balancing and capacity requirements.

15. A storage medium readable by a computer, the medium encoding a computer process to provide a method for targeted content presentation in a communications network, the computer process comprising:
a processing portion for determining targeted user characteristics;
and
a processing portion for presenting content in accordance with said characteristics.
